(19) United States
(12) Patent Application Publication
(10) Pub. No.: US 2014/0318006 A1
(43) Pub. Date: Oct. 30, 2014

(54) APPARATUS FOR LIGHTING A MINI GREENHOUSE

(71) Applicant: Future Harvest Development Ltd., (US)

(72) Inventors: Mark William Sutherland, Kelowna (CA); Barry Edward Stonehouse, Kelowna (CA)

(73) Assignee: Future Harvest Development Ltd., Kelowna (CA)

(21) Appl. No.: 13/871,583

(22) Filed: Apr. 26, 2013

(51) Int. Cl. A01G 9/16

(52) U.S. Cl. CPC A01G 9/16
USPC 47/17

(57) ABSTRACT

There is disclosed a dome and lighting apparatus for a mini greenhouse. In an aspect, the dome has one or more grooves or channels adapted to receive a lighting module. In an embodiment, the one or more channels are positioned laterally or longitudinally on the top surface of a dome, such that one or more lighting modules may be received thereon to evenly light the entirety of the mini greenhouse under the dome. A groove or channel may be suitably shaped to accommodate a lighting element. The groove or channel may further include shoulders on either side to accommodate a reflector for the lighting element, which may be suitably angled to direct the light downwardly into the mini greenhouse. By aligning respective grooves or channels of two domes placed side-by-side, a lighting module may be received over both domes within the aligned grooves or channels.

### FIELD OF THE INVENTION

The present disclosure relates generally to a mini greenhouse for growing plants indoors, and more particularly to an apparatus for lighting a mini greenhouse.

### BACKGROUND OF THE INVENTION

The ability to grow flower and vegetable seedlings, propagate fresh cuttings, or to grow fresh herbs indoors is highly desirable to gardeners, as they provide more control over the growing conditions from seeds, bulbs or fresh cuttings, until they can be harvested, or transplanted to potted plants and flowers.

Various prior art solutions provide enclosures or domes, together with lighting to provide a suitable greenhouse environment. However, the ability to provide adequate lighting has been a challenge due to the difficulty in properly positioning lamps at the proper distance and in a correct orientation over the desired lighting area.

Therefore, what is needed is an improved mini greenhouse dome and lighting apparatus which overcomes at least some of the limitations in the prior art.

### SUMMARY OF THE INVENTION

The present disclosure relates generally to an apparatus for lighting a mini greenhouse.

In an aspect, there is provided a dome having one or more grooves or channels adapted to receive and support a lighting module.

In an embodiment, one or more channels are positioned laterally or longitudinally along the top surface of a dome, such that one or more lighting modules may be received thereon to evenly light the desired lighting area of the mini greenhouse under the dome.

A channel may be suitably shaped to accommodate a rounded lighting element, such as a long, cylindrical fluorescent lighting bulb, for example. A channel may further include shoulders on either side to accommodate a reflector for the lighting element, which may be suitably angled to direct the light downwardly into the mini greenhouse. One or more protrusions may be positioned adjacent the shoulders to properly center the reflector and the lighting element over the channel.

In another embodiment, one or more notches may be provided in the shoulder area or on the protrusions, to allow the reflectors to be positioned at different angles over the channel.

In an embodiment, two domes may be positioned next to each other with channels on the respective domes aligned in order to receive a lighting module across both domes. In this manner, there is significant flexibility provided in the positioning of the lighting modules, such that lighting is provided evenly under both domes. The lighting modules may also be moved, if desired, in order to redirect the light over different areas under the domes.

In another embodiment, the domes may be a clear color, a translucent frosted white color, or a different translucent color suitable for the plant, flower or herb being grown.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### DESCRIPTION OF THE DRAWINGS

FIGS. 1A and 1B show an illustrative example of components of an apparatus in accordance with an embodiment;

FIGS. 2A and 2B show a line drawing of the components of apparatus of FIGS. 1A and 1B as transparent materials;

FIG. 3A shows a detailed top view of the apparatus of FIG. 1;

FIG. 3B shows a detailed side view of the apparatus of FIG. 1;

FIG. 4 shows a detailed top view of two units with channels aligned;

FIG. 5A shows a perspective view of the apparatus of FIG. 1 in use, with a lighting module positioned longitudinally over the dome; and

FIG. 5B shows a perspective view of two domes positioned next to each other with their respective channels aligned, and two lighting modules positioned over both domes.

In the drawings; embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present disclosure relates generally to a dome and lighting apparatus for a mini greenhouse.

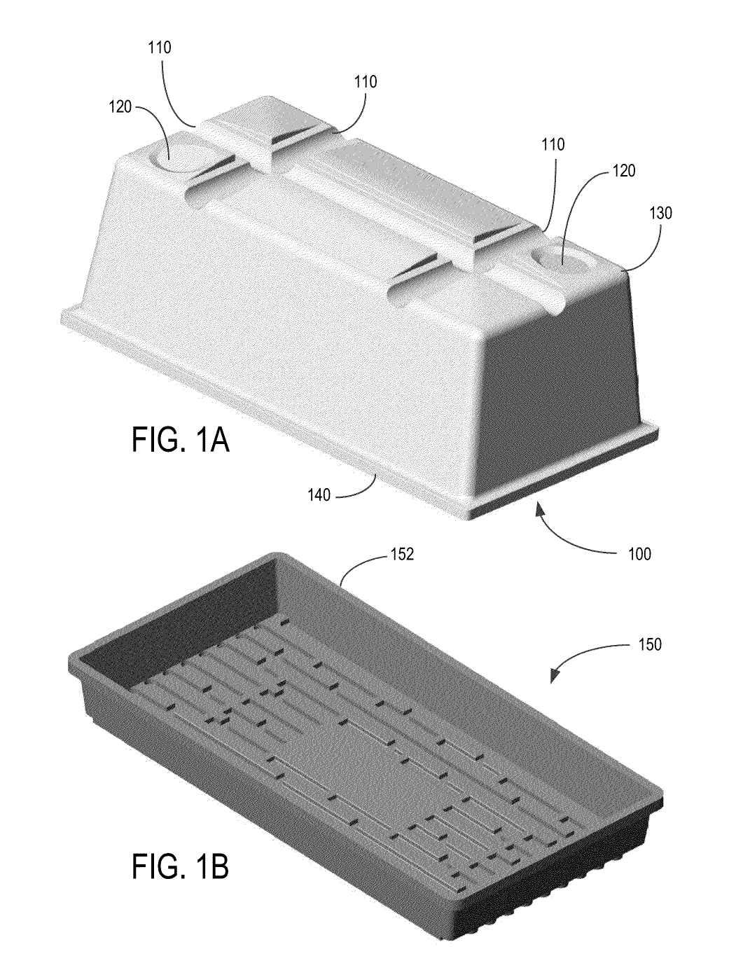

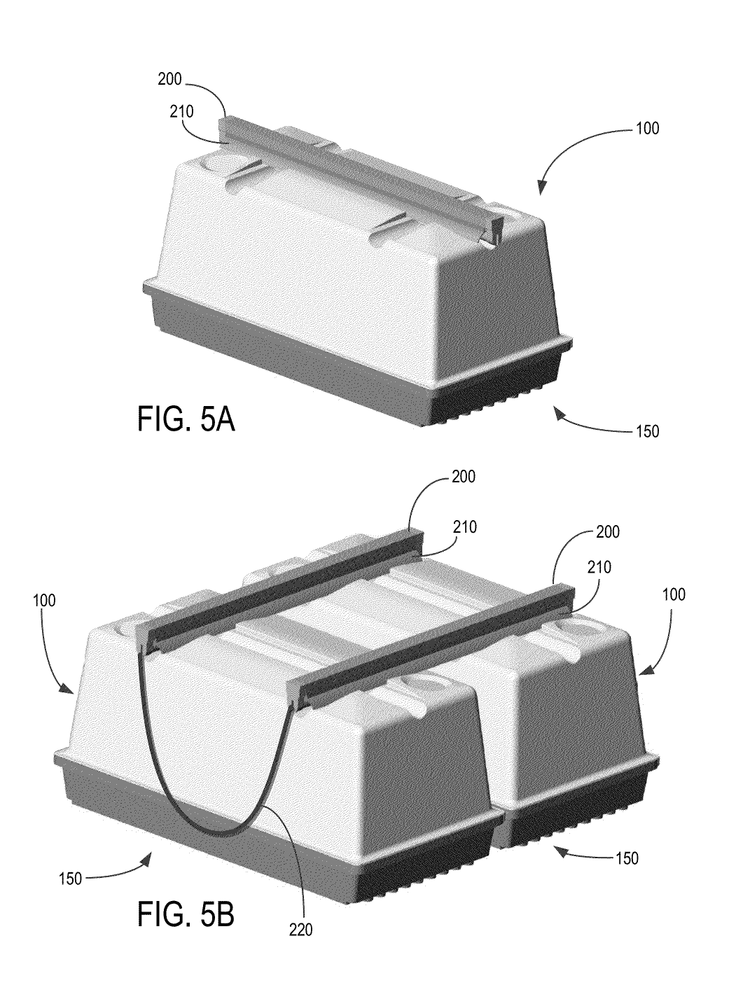

Now referring to FIGS. 1A and 1B, shown is an illustrative example of an apparatus 100 in accordance with an illustrative embodiment. In this example, the apparatus comprises a dome 130 having one or more grooves or channels 110 adapted to receive one or more lighting modules (see lighting modules 200 in FIGS. 5A and 5B discussed further below). As shown in this example, the one or more channels 110 are positioned laterally or longitudinally, along the top surface of the dome 130, such that one or more lighting modules (e.g. lighting module 200 of FIGS. 5A and 5B) may be received thereon to evenly light the entirety of the mini greenhouse formed under the dome 130. The dome 130 may be reinforced along its bottom edge 140, such that the dome is strengthened from bending or twisting out of shape. The bottom edge 140 of dome 130 is suitably steed and shaped to be received on a corresponding top edge 152 of a container 150, which may be used to contain growing soil, or to hold a plurality of small pots holding growing soil or hydroponic water containers.

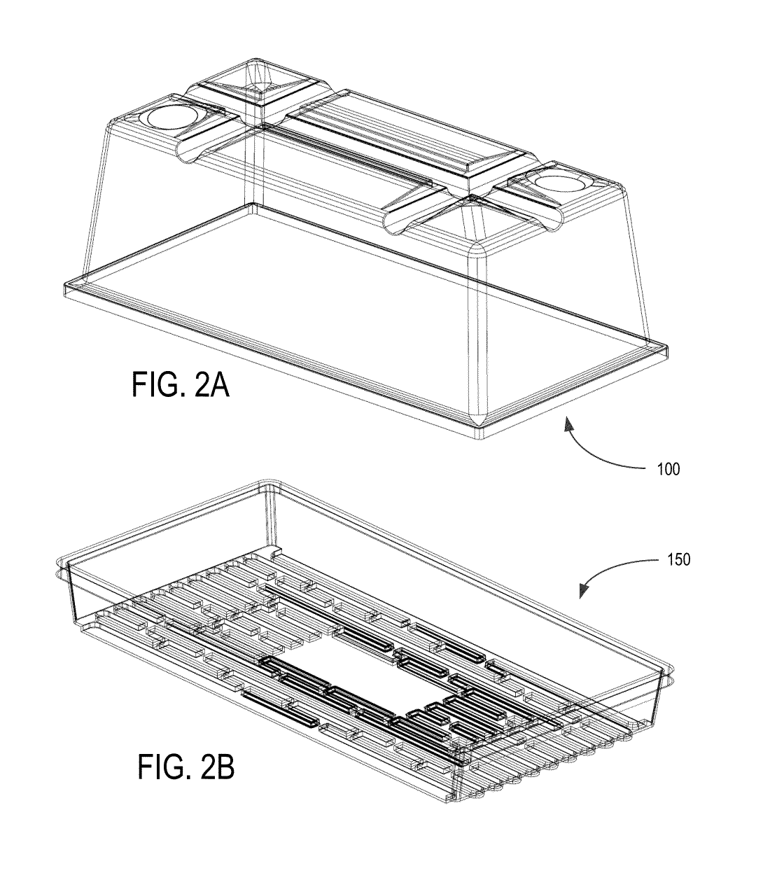

As shown in FIGS. 2A and 2B, in order to allow light to pass through the dome 130, the dome 130 is either a transparent or translucent material, and may be made from a suitable plastic material or tempered glass. The container 150 may be transparent, translucent, or opaque, and may be made from a suitable plastic material, a glass material, or a metal to provide additional structural strength.

In an embodiment, the dome 130 may further include one or more vents 120 to allow air to circulate into and out of the dome 130. If necessary, a fan may be placed at a vent 120 in order to promote air circulation within the dome 130.

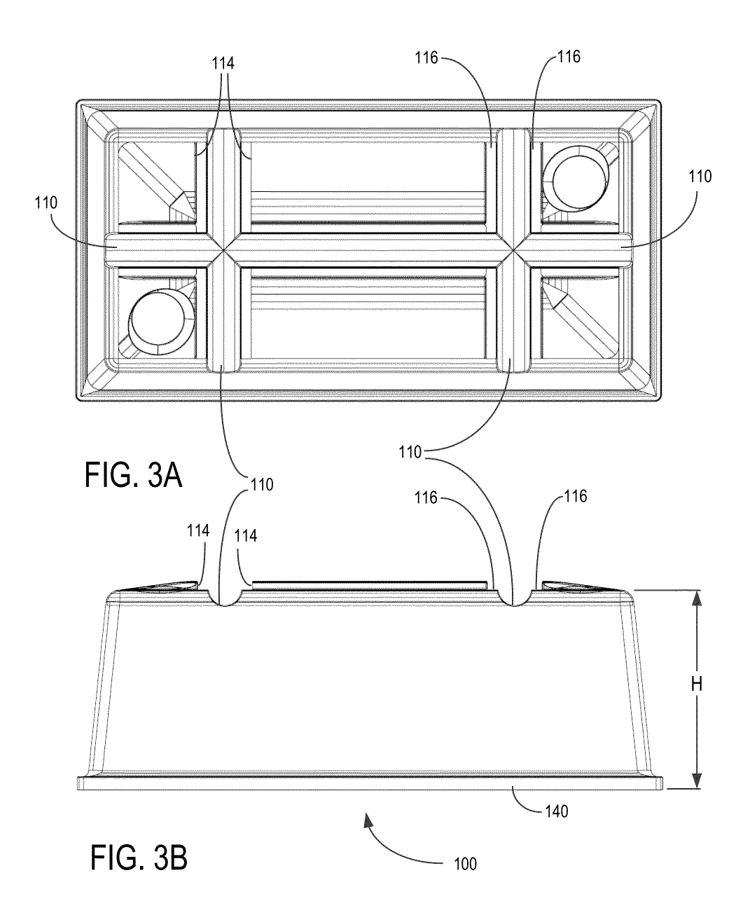

Now referring to FIGS. 3A and 3B, the one or more channels 110 may have a generally curved shape to accommodate a rounded lighting element, such as a long, cylindrical fluorescent lighting bulb of lighting module 200. (FIGS. 5A and 5B), for example. The one or more channels 110 may further include a pair of shoulders 116 on either side of the channel 110 to accommodate a reflector (e.g. reflector 210 of FIGS. 5A and 5B) for the lighting element 200 (FIGS. 5A and 5B). Protrusions 114 adjacent the shoulders 116 may abut the reflector 210 to properly center the reflector 210 over the channel 110.

In an embodiment, one or more notches may be provided on the shoulders 116, or two or more levels may be provided in the protrusions 114, such that different sizes of lighting modules 200 may be accommodated over the one or more channels 110. Furthermore, the angle of a reflector 210 may be adjusted to reflect light from a lighting module 200 more evenly across the area covered by the dome 130. FIGS. 3A and 3B show the shoulders 116, protrusions 114 and curved shape of the laterally oriented channels 110 in more detail.

Still referring to FIG. 3A and 3B, in an embodiment, the height H of the dome 130 is selected to provide the appropriate support height for the one or more lighting modules 200 positioned an top of the dome 130. By properly selecting a height for the dome 130, and choosing a lighting module 200 with suitable luminosity and efficiency, the amount of power required to light the mini-greenhouse may be minimized.

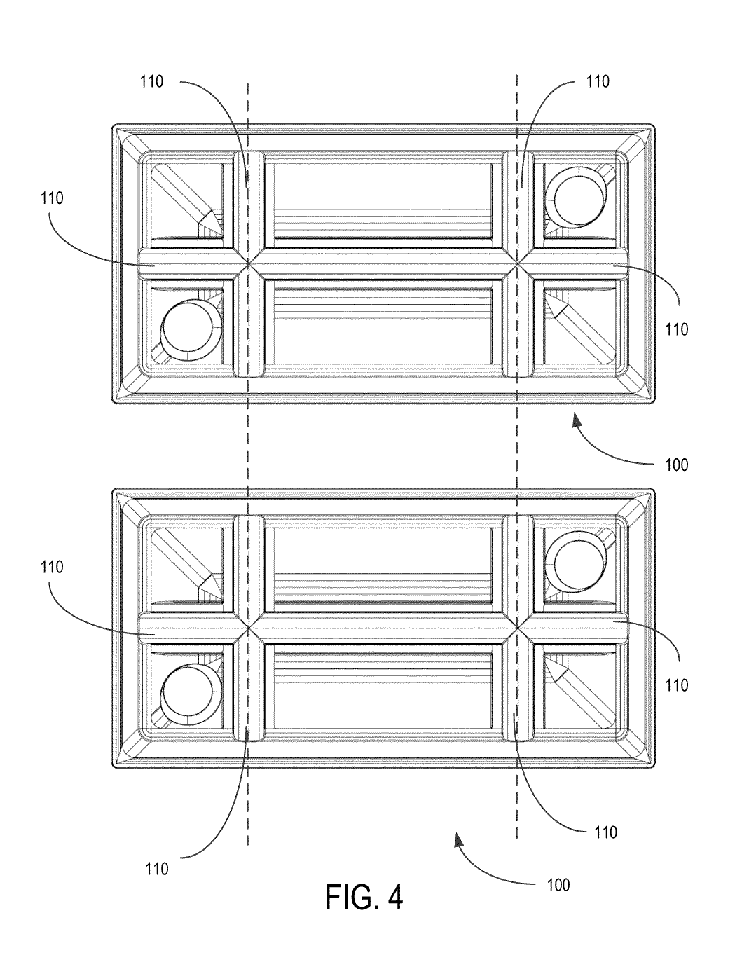

Now referring to FIG. 4, shown is a top view of two units of the apparatus 100 in which the laterally oriented channels 110 of the two units are aligned. Thus, when two domes 130 are positioned adjacent each other with their respective channels 110 aligned in the manner shown, lighting modules 200 may be positioned across both domes 130 (as shown in FIG. 5B, for example). In this manner, significant flexibility is provided in positioning and orientation of the lighting modules 200, such that lighting is provided evenly under the areas covered by the domes 130. If desired, the lighting modules 200 may also be moved longitudinally or laterally in order to redirect the light over different areas under the domes 130 as the application may require.

Advantageously, as shown in FIG. 5B, when the lighting modules 200 are positioned on top of the domes 130, two or more lighting modules 200 may be operationally connected in series, as shown by a connecting electrical cord 220, such that only one outlet or extension cord can be used for multiple lighting modules. Furthermore, one lighting control may operate multiple lighting modules that may be connected in series. Alternatively, the lighting modules 200 may also be connected in parallel, for example to a power bar with multiple outlets (not shown), and controlled by a switch on the power bar.

Preferably, the domes 130 are a transparent, clear color. However, the domes 130 may also be translucent (e.g. a frosted white color), or a different color as may be desired.

Thus, in an aspect, there is provided a dome for a mini greenhouse, comprising: a top surface with one or more grooves or channels formed therein, said one or more grooves or channels adapted to receive a lighting module thereon.

In an embodiment, the one or more grooves or channels are oriented laterally or longitudinally on the top surface of the dome.

In another embodiment, the dome further comprises a pair of shoulders on either side of the grooves or channels, the pair of shoulders adapted to receive a reflector of a lighting module thereon.

In another embodiment, the dome further comprises a protrusion adjacent each shoulder, the protrusion adapted to limit and center a lighting module over the one or more grooves or channels.

In another embodiment, the one or more grooves or channels are positioned such that the one or more grooves or channels are aligned when two domes are placed side-by-side or end-to-end.

In another embodiment, the dome is further adapted to receive a lighting module that is sufficiently long to stretch across the two domes when the two domes are placed side-by-side or end-to-end with at least one groove or channel aligned between the two domes.

In another embodiment, the dome is further adapted to receive lighting modules that are operationally connectable in series when the two domes are placed side-by-side or end-to-end.

In another embodiment, the height of the dome is selected to provide a sufficient angle of lighting from a lighting module received on top of the one or more grooves or channels.

In another embodiment, the dome is further adapted to receive a lighting module with luminosity sufficient to provide lighting across a desired lighting area under the dome.

In another embodiment, the dome is further adapted to receive a lighting module having an adjustable reflector to adjust the angle of reflection of light over the desired lighting area under the dome.

In another aspect, there is provided an apparatus for lighting a mini greenhouse, comprising: a lighting module; and a dome having one or more grooves or channels on a top surface; said one or more grooves or channels adapted to receive the lighting module thereon.

In an embodiment, the one or more grooves or channels are oriented laterally or longitudinally on the top surface of the dome.

In another embodiment, the apparatus further comprises a pair of shoulders on either side of the grooves or channels, the pair of shoulders adapted to receive a reflector of a lighting module thereon.

In another embodiment, the apparatus further comprises a protrusion adjacent each shoulder, the protrusion adapted to center the lighting module over the one or more grooves or channels.

In another embodiment, the one or more grooves or channels are positioned such that the one or more grooves or channels are aligned when two domes are placed side-by-side or end-to-end.

In another embodiment, the lighting module is sufficiently long to stretch across the two domes when the two domes are placed side-by-side or end-to-end.

In another embodiment, the lighting modules operationally connectable in series when the two domes are placed side-by-side or end-to-end.

In another embodiment, the height of the dome is selected to provide a sufficient angle of lighting from a lighting module received on top of the one or more grooves or channels.

In another embodiment, the luminosity of the lighting module is selected to provide sufficient lighting across a desired lighting area under the dome.

In another embodiment, the lighting module has an adjustable reflector to adjust the angle of reflection of light over the desired lighting area under the dome.

While various embodiments and illustrative examples have been described above, it will be appreciated that these embodiments and illustrative examples are not limiting, and the scope of the invention is defined by the following claims.

1. A dome for a mini greenhouse, comprising:
a top surface with one or more grooves or channels formed therein, said one or more grooves or channels adapted to receive a lighting module thereon.

2. The dome as claimed in claim 1, wherein the one or more grooves or channels are oriented laterally or longitudinally on the top surface of the dome.

3. The dome as claimed in claim 2, further comprising a pair of shoulders on either side of the grooves or channels, the pair of shoulders adapted to receive a reflector of a lighting module thereon.

4. The dome as claimed in claim 3, further comprising a protrusion adjacent each shoulder, the protrusion adapted to limit and center a lighting module over the one or more grooves or channels.

5. The dome of claim 2, wherein the one or more grooves or channels are positioned such that the one or more grooves or channels are aligned when two domes are placed side-by-side or end-to-end.

6. The dome of claim 5, wherein the dome is further adapted to receive a lighting module that is sufficiently long to stretch across the two domes when the two domes are placed side-by-side or end-to-end with at least one groove or channel aligned between the two domes.

7. The dome of claim 5, wherein the dome is further adapted to receive lighting modules that are operationally connectable in series when the two domes are placed side-by-side or end-to-end.

8. The dome of claim 1 wherein the height of the dome is selected to provide a sufficient angle of lighting from a lighting module received on top of the one or more grooves or channels.

9. The dome of claim 8, wherein the dome is adapted to receive a lighting module with luminosity sufficient to provide lighting across a desired lighting area under the dome.

10. The dome of claim 9, wherein the dome is adapted to receive a lighting module having an adjustable reflector to adjust the angle of reflection of light over the desired lighting area under the dome.

11. An apparatus for lighting a mini greenhouse, comprising:
a lighting module; and
a dome having one or more grooves or channels on a top surface, said one or more grooves or channels adapted to receive the lighting module thereon.

12. The apparatus as claimed in claim 11, wherein the one or more grooves or channels are oriented laterally or longitudinally on the top surface of the dome.

13. The apparatus as claimed in claim 12, further comprising a pair of shoulders on either side of the grooves or channels, the pair of shoulders adapted to receive a reflector of a lighting module thereon.

14. The apparatus as claimed in claim 13, further comprising a protrusion adjacent each shoulder, the protrusion adapted to center the lighting module over the one or more grooves or channels.

15. The apparatus of claim 11, wherein the one or more grooves or channels are positioned such that the one or more grooves or channels are aligned when two domes are placed side-by-side or end-to-end.

16. The apparatus of claim 15, wherein the lighting module is sufficiently long to stretch across the two domes when the two domes are placed side-by-side or end-to-end.

17. The apparatus of claim 15, wherein the lighting modules operationally connectable in series when the two domes are placed side-by-side or end-to-end.

18. The apparatus of claim 11, wherein the height of the dome is selected to provide a sufficient angle of lighting from a lighting module received on top of the one or more grooves or channels.

19. The apparatus of claim 18, wherein the luminosity of the lighting module is selected to provide sufficient lighting across a desired lighting area under the dome.

20. The apparatus of claim 19, wherein the lighting module has an adjustable reflector to adjust the angle of reflection of light over the desired lighting area under the dome.
